(19) United States
(12) Patent Application Publication
(10) Pub. No.: US 2007/0006753 A1
(43) Pub. Date: Jan. 11, 2007

(54) Web-fed rotary press having sleeve-shaped printing blankets

(75) Inventors: Roman Herold, Augsburg (DE); Peter Knauer, Muenster/Lech (DE); Josef Singler, Binswangen (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/436,847

(22) Filed: May 18, 2006

(30) Foreign Application Priority Data
May 19, 2005 (DE) 10 2005 022 986.7

(51) Int. Cl. B41F 13/02

(52) U.S. Cl. 101/220

(57) ABSTRACT

A web-fed rotary offset press is disclosed. The press is designed for using sleeve technology, it being possible for sleeve-shaped rubber blankets to be pushed onto the rubber-covered cylinders in the axial direction. Finite printing plates are placed onto the plate cylinders in a conventional manner, it being possible to fix the ends of the finite plates in slots of the plate cylinders. Rubber-covered cylinders are used which have a double circumference, while the plate cylinders have a single circumference. As a result, the rigidity of the cylinder system is increased substantially, with the result that a stable web run and in-register printing are possible in wide machines over 1400 mm, without it being necessary for modifications to be performed on the cylinders or the compressibility or thickness of the rubber layers of the sleeves to be changed in the axial direction.

This application claims the priority of German Patent Document No. 10 2005 022 986.7, filed May 19, 2005, the disclosure of which is expressly incorporated by reference herein.

### BACKGROUND AND SUMMARY OF THE INVENTION

The invention relates to a web-fed rotary offset press having at least one press unit which has two pairs of plate cylinders and rubber-covered cylinders, it being possible to push sleeve-shaped printing blankets in the form of sleeves onto the rubber-covered cylinders and it being possible to print a printing-material web between the rubber-covered cylinders.

Web-fed rotary offset presses of this type have been used for many years. In these known machines, in each case both the plate cylinders, also called form cylinders, and the rubber-covered cylinders, also called transfer cylinders, have what is known as a single circumference. This means that the plate cylinder rolls once on the rubber-covered cylinder in each case during one revolution of the plate cylinders and the rubber-covered cylinders, because the circumferences of both cylinders are equally large. Moreover, in particular in illustration printing, there are web-fed rotary offset presses of this type which operate with conventional rubber blankets, that is to say the blanket cylinders have axial clamping channels in which the ends of the printing blankets which are to be clamped onto the rubber-covered cylinders can be fixed. Web-fed rotary offset presses with axial clamping channels in the blanket cylinders generate oscillations on account of the relatively large width of the rubber-covered cylinder channels, which oscillations have an unfavorable effect on the quality of printing. These oscillations become greater, in particular, with an increasing length of the cylinders, that is to say with an increasing width of the printing press, as the absence of rigidity of a single-size rubber-covered cylinder also increasingly makes itself noticed disadvantageously. For this reason, web-fed rotary offset presses have been equipped up to now with what are known as double-size rubber-covered cylinders, that is to say the rubber-covered cylinders have a double circumference in comparison with the plate cylinders, while the plate cylinders have a single circumference.

In the use of sleeve technology, that is to say in the use of sleeve-shaped printing blankets, the use of clamping slots in the rubber-covered cylinders is superfluous, with the result that these above-mentioned sleeve presses, that is to say rubber-covered cylinders with sleeve-shaped printing blankets, do not have a double circumference, but have been able to have exclusively a single circumference. This has been sufficient in the previously constructed sleeve presses.

It is an object of the present invention to provide web-fed rotary offset presses for using sleeve technology, that is to say for making the use of sleeve-shaped printing blankets possible, which can have a greater width than the previously known printing presses and in which printing-material webs with a great width can therefore be printed, it being possible to use single circumferences for the plate cylinders without uncontrollably high flexural oscillations occurring.

Advantageous developments of the invention result from the description in conjunction with the drawing.

One substantial advantage of the web-fed rotary offset press according to the invention lies in the fact that no uncontrollable high deflection occurs in these rubber-covered cylinders and a high print quality is therefore also possible in wide web widths, that is to say in machines for large web widths, without a modification to the rubber-covered cylinder diameters in the axial direction or different compressibilities or rubber-layer thicknesses in the axial direction of the cylinders being required, a stable web run therefore being ensured in the web-fed rotary offset presses which are constructed according to the invention, and satisfactory in-register printing resulting.

### BRIEF DESCRIPTION OF THE DRAWINGS

FIG. 1 is a schematic illustration of a press unit of a web-fed rotary offset press in accordance with the principles of the present invention.

### DETAILED DESCRIPTION OF THE DRAWINGS

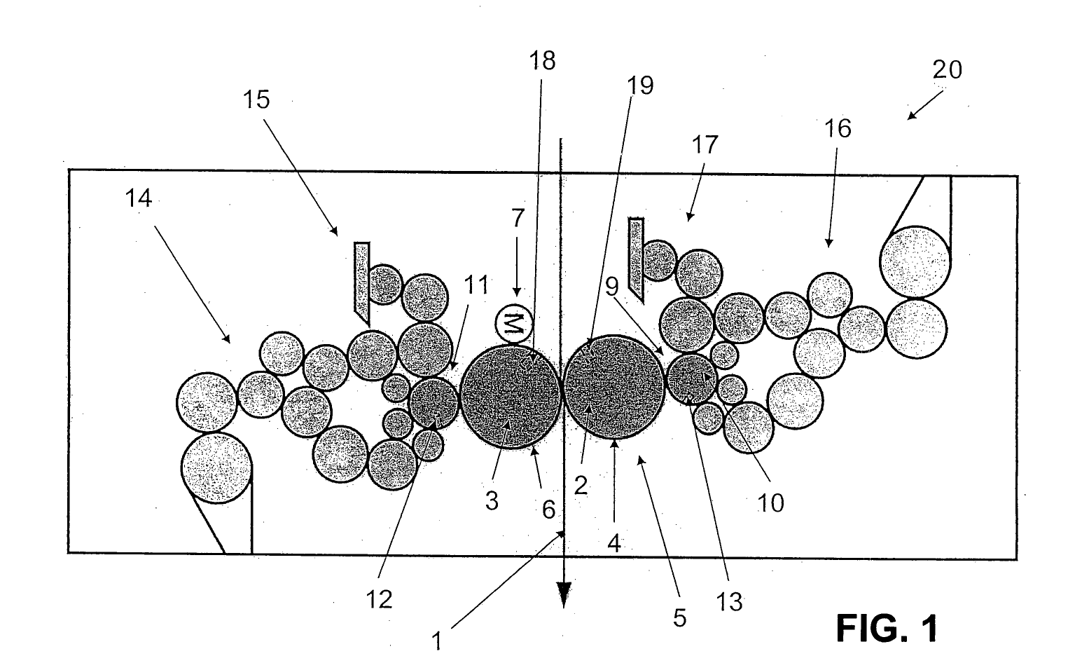

In the following text, the invention will be described using an exemplary embodiment with reference being made to FIG. 1.

In this, a press unit 20 of a web-fed rotary offset press is described, in which a printing-material web 1 can preferably be passed horizontally between two rubber-covered cylinders 2, 3, with the result that the printing-material web 1 can be provided with printing on both sides. The rubber-covered cylinder 3 can be driven by a motor 7 and the associated plate cylinder 11 can be driven by this rubber-covered cylinder 3 via a spur toothing system. As can be understood, each rubber-covered cylinder 2, 3 may be connected to a separate drive motor 7, and in each case the associated plate cylinder 10, 11 can be driven by the associated rubber-covered cylinder 2, 3 via a spur toothing system

According to the invention, in each case one rubber sleeve which can be pushed axially onto the blanket cylinders 2, 3 can be pushed as a sleeve-shaped rubber blanket 4, 6 onto the rubber-covered cylinders 2, 3, which are also called transfer cylinders. As is known, the cylinders 2, 3 can remain in the machine during this process, the mounting being released only on one side of the cylinders 2, 3 in each case for changing a rubber sleeve or a sleeve-shaped rubber blanket 4, 6, with the result that the sleeve-shaped rubber blankets 4, 6 which are to be applied can be pushed axially onto the blanket cylinders 2, 3 through the side wall. The sleeve-shaped rubber blankets 4, 6 preferably have a metallic carrier, for example made from nickel or a carrier made from carbon-fiber-reinforced plastic, which can be expanded by air, resulting in simple application of the sleeve-shaped rubber blankets 4, 6 onto the cylinders 2, 3 through the side wall of the printing press.

Multiple-layer rubber layers are preferably applied to the carrier sleeves, of which one rubber layer is compressible, the sleeve-shaped rubber blanket 4, 6 having in each case one printing surface on the outside, as indicated by the reference numeral 5 of the sleeve-shaped rubber-blanket 4. A printing surface 5 of this type can be formed in each case by a separate layer which forms the outer layer of the sleeve-shaped rubber blanket 4 or 6. Sleeve-shaped rubber blankets 4, 6 of this type are usually also called rubber sleeves, and the rubber layers can be configured to be endless or they can have a joint, that is to say a gap, which can also be filled with a material. In this case, the sleeve-shaped rubber blankets have to be applied to the rubber-covered cylinders 2, 3 in each case in register, that is to say in a defined circumferential position. As a result of the configuration according to the invention of the web-fed rotary offset press shown, it is not necessarily required, despite a great machine width of over 1400 mm, to change the diameters of the cylinder bodies in the axial direction or to configure the rubber layers in the axial direction with a different compressibility or thickness, or to equip the rubber sleeves with different diameters from the edge to the center, in order to counteract the deflections and the resulting web conveying problems of the known rubber-covered cylinders with a single circumference. The rubber-covered cylinders 2, 3 according to the invention therefore no longer require these measures, as are used in known sleeve machines with a relatively large width.

Each of the single-size plate cylinders with clamping slots 12, 13 for fixing the printing plates is assigned an inking unit 14, 16 and a damping unit 15, 17, with the result that the printing plates which are arranged on the plate cylinders 10, 11 can be fixed in a conventional manner.

It is shown in FIG. 1 with dashed lines that in conventional machines, in which sleeve technology is not used, the rubber-covered cylinders 2, 3 have to have at least one axially extending clamping channel 18, 19, in order to fix the rubber blanket which is to be applied in each case with its ends on the rubber-covered cylinders 2, 3. As shown, these clamping channels 18, 19 are superfluous in printing presses with sleeve technology, but up to now machines with sleeve technology have been used in each case with rubber-covered cylinders with a single circumference, either modifications being performed on the cylinder diameters in the axial direction, as shown, in order to avoid pressing differences, or the compressibility or rubber-layer thickness has been configured differently in the axial direction, with the result that the web conveying problems could be counteracted in narrow rubber-covered cylinders of this type.

Further in accordance with the principles of the present invention, the rubber-covered cylinders 2, 3 may have internal cooling. Also, the rubber layer 5 of a tubular rubber blanket 4 has a gap in the axial direction, and a circumferential register marking is provided on the rubber-covered cylinder 2, onto which circumferential register marking the tubular rubber blanket 4 can be positioned in register in the circumferential direction after it has been pushed onto the rubber-covered cylinder 2.

The use according to the invention of blanket cylinders with a double circumference also improves the accessibility to the individual components of the press units 20 in comparison with machines having rubber-covered cylinders which have a single circumference.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A web-fed rotary offset press having at least one printing unit which comprises a first press unit having a first plate cylinder and a first rubber-covered cylinder, and a second press unit having a second plate cylinder and a second rubber-covered cylinder, wherein a printing-material web is passable between the first and second rubber-covered cylinders such that the printing-material web is provided with a pressure on both sides, and wherein the first and second plate cylinders are each provided with a finite plate, the ends of which are fixable in respective clamping slots of the plate cylinders, and further wherein first and second tubular rubber blankets are pushable axially onto the first and second rubber-covered cylinders, respectively, and the first and second rubber-covered cylinders have a double circumference and the first and second plate cylinders have a single circumference and wherein a length of the first and second plate cylinders and the first and second rubber-covered cylinders is >1400 mm.

2. The web-fed rotary offset press having at least one printing unit according to claim 1, wherein the printing-material web is guidable horizontally between the first and second rubber-covered cylinders, and wherein a thickness and/or rigidity of a rubber layer of the first and second tubular rubber blankets is uniform in an axial direction.

3. The web-fed rotary offset press having at least one printing unit according to claim 1, wherein a rubber layer of the first and second tubular rubber blankets has a sleeve which is expandable by air and at least one compressible rubber layer, on which a printing cover layer is formed.

4. The web-fed rotary offset press having at least one printing unit according to claim 1, wherein one of the first and second rubber-covered cylinders is drivable by a motor and an associated plate cylinder is drivable by the one rubber-covered cylinder via a spur toothing system.

5. The web-fed rotary offset press having at least one printing unit according to claim 1, wherein the first and second rubber-covered cylinders have internal cooling.

6. The web-fed rotary offset press having at least one printing unit according to claim 1, wherein a rubber layer of one of the first and second tubular rubber blankets has a gap in an axial direction, and wherein a circumferential register marking is provided on a respective rubber-covered cylinder, onto which circumferential register marking the one tubular rubber blanket is positionable in register in a circumferential direction after it has been pushed onto the respective rubber-covered cylinder.

7. The web-fed rotary offset press having at least one printing unit according to claim 1, wherein the first and second rubber-covered cylinders are each connected to a separate drive motor, and wherein an associated plate cylinder is drivable by the associated rubber-covered cylinder via a spur toothing system, and further wherein the first and second plate cylinders are assigned an inking unit and a damping unit.

8. A web-fed rotary offset press having at least one printing unit, comprising:
a first press unit having a first plate cylinder and a first transfer cylinder, wherein a first sleeve-shaped rubber blanket is disposed on the first transfer cylinder; and
a second press unit having a second plate cylinder and a second transfer cylinder, wherein a second sleeve-shaped rubber blanket is disposed on the second transfer cylinder;
wherein the first and second transfer cylinders have a double circumference and the first and second plate cylinders have a single circumference and wherein a length of the first and second plate cylinders and the first and second transfer cylinders is >1400 mm.

9. The web-fed rotary offset press having at least one printing unit according to claim 8, wherein a thickness of a rubber layer of the first and second sleeve-shaped rubber blankets is uniform in an axial direction.

10. The web-fed rotary offset press having at least one printing unit according to claim 8, wherein a rigidity of a rubber layer of the first and second sleeve-shaped rubber blankets is uniform in an axial direction.

11. The web-fed rotary offset press having at least one printing unit according to claim 8, wherein the first and second sleeve-shaped rubber blankets have a constant diameter from an edge to a center of the sleeve-shaped rubber blankets.

12. The web-fed rotary offset press having at least one printing unit according to claim 8, wherein the first and second plate cylinders and the first and second transfer cylinders have a constant diameter in an axial direction.

13. The web-fed rotary offset press having at least one printing unit according to claim 8, wherein the first and second sleeve-shaped rubber blankets include an expandable metallic carrier.

14. The web-fed rotary offset press having at least one printing unit according to claim 8, wherein the first and second sleeve-shaped rubber blankets include multiple rubber layers and wherein a layer of the multiple layers is compressible.

15. The web-fed rotary offset press having at least one printing unit according to claim 8, wherein the first and second sleeve-shaped rubber blankets have an endless configuration.

16. The web-fed rotary offset press having at least one printing unit according to claim 8, wherein the first and second sleeve-shaped rubber blankets include a gap.

17. The web-fed rotary offset press having at least one printing unit according to claim 16, wherein the gap is filled with a material.

18. The web-fed rotary offset press having at least one printing unit according to claim 16, wherein the first and second sleeve-shaped rubber blankets are disposed on the first and second transfer cylinders, respectively, in a defined circumferential position.
